(19) United States
(12) Patent Application Publication
(10) Pub. No.: US 2023/0142382 A1
(43) Pub. Date: May 11, 2023

(54) PLATE HEAT EXCHANGER

(71) Applicant: SGL CARBON SE, Wiesbaden (DE)

(72) Inventors: Werner ANETSEDER, Meitingen (DE); Karl BIRKNER, Meitingen (DE)

(73) Assignee: SGL CARBON SE, Wiesbaden (DE)

(21) Appl. No.: 17/908,603

(22) PCT Filed: Mar. 9, 2021
(86) PCT No.: PCT/EP2021/055848

§ 371 Date: Sep. 1, 2022

(30) Foreign Application Priority Data
Mar. 12, 2020 (DE) 10 2020 203 223.8

(51) Int. Cl. F28D 9/00; F28F 21/02; F28F 21/04; F28F 21/08; F28F 3/10

(52) U.S. Cl. CPC F28D 9/0043; F28F 21/02; F28F 21/04; F28F 21/08; F28F 3/10; F28F 2230/00

(57) ABSTRACT

A plate heat exchanger with two heat exchange plates forming a channel system between the heat exchange plates, the channel system being sealed by a sealing member. The channel system includes a support member, the support member is arranged at a distance from the sealing member and a support member material is different from a material of a heat exchange plate.

### FIELD

The present invention relates to a plate heat exchanger and to the use of the plate heat exchanger for transferring heat between media.

### BACKGROUND

Plate heat exchangers contain a stack of heat-exchanging plates, by means of which heat is transferred from one medium to another medium. Adjacent plates form a channel system through which a medium flows. A medium is understood to mean a liquid or a gas without ruling out the fact that particles may be present in the liquid or the gas.

In principle, a distinction is made between unsealed and sealed plate heat exchangers. In the unsealed design, the spaces between the plates are sealed by a rigid connection between the plates, for example by welding or soldering or by fusion technology.

In sealed plate heat exchangers, the heat-exchanging plates lie one on top of the other at the edges and are separated by gaskets. Such sealed plate heat exchangers are known from EP 1996889 B1, for example. This document describes a plate heat exchanger consisting of a plurality of plates, the individual plates being stacked and each interconnected by circumferential gaskets and a channel system being formed that extends in a meander-like manner and the sidewalls of the guide channels comprising apertures. An improved heat transfer capacity and reduced pressure drop are intended to be achieved.

### SUMMARY

The object of the present invention is to provide sealed plate heat exchangers, which permanently withstand high pressure differences between the media and relative to the environment during operation and which are also stable with respect to temporal fluctuations or jumps in the pressure of a medium.

This object is achieved by a plate heat exchanger comprising two heat-exchanging plates, which form a channel system arranged between the heat-exchanging plates that is sealed by a sealing element, wherein the channel system comprises a supporting element and wherein the supporting element is spaced apart from the sealing element and a supporting element material differs from a material of a heat-exchanging plate.

Preferred embodiments of the plate heat exchanger according to the invention can be found in the following detailed description.

It goes without saying that the number of plates is not limited to two. A person skilled in the art would select the number of heat-exchanging plates in accordance with the desired heat transfer capacity. The larger the number and surface area of the heat-exchanging plates, the greater the heat transfer capacity.

According to the invention, the channel system is arranged between two heat-exchanging plates. The two surfaces facing one another of adjacent heat-exchanging plates define flow channels of the channel system. For this purpose, at least one of the two facing surfaces is profiled. Graphite heat-exchanging plates and silicon carbide heat-exchanging plates are often milled on one side such that only one of the two facing surfaces is profiled. The channel system is then produced by the profiled surface against a flat surface of the next plate in the stack. However, both the facing surfaces of the two heat-exchanging plates can also be profiled. Embossed plates are preferably profiled on both surfaces, for example those made from the F100 material provided by SGL Carbon. F100 material is a material containing graphite particles and fluoropolymer.

The joining connection between the plates is a releasable joining connection. Releasable can be understood to mean that the plates can be released from one another without destroying the plates. Joining connections that are not non-destructive would be integral bonds such as soldering, welding and gluing, for example.

Within the present invention, a sealing element is understood to mean means, for example a gasket, for hermetically sealing the channel system with respect to the surrounding atmosphere.

A supporting element can be understood to mean an element that is arranged between the heat-exchanging plates lying on top of one another and supports these against one another.

Within the present invention, the supporting element is spaced apart from the sealing element. This means that the supporting element and sealing element do not merge but are elements that are separated from one another.

The supporting element is preferably a supporting connection between the two heat-exchanging plates. This means that some of a force acting on one of the heat-exchanging plates orthogonally to the heat-exchanging plate plane is transferred by the supporting element to the other heat-exchanging plate that is next in the direction of force.

The sealing element can comprise a circumferential sealing element region. Such a sealing region can, for example, be found in a frame gasket as shown in FIG. 4 of DE102008048014 A1, for example. The sealing element can also be a self-contained circumferential tape or can form a tape contour, which is closed on all sides, by means of overlapping tape regions, for example tape ends. This continuously and reliably seals the channel system with respect to the environment. The tape can be solid or pasty, wherein the width, thickness and the sealing element material or the sealing element materials are always adjusted to match one another so as to achieve adequate sealing action and the smallest possible tendency to creep and to simultaneously ensure sufficient resistance of the sealing element to corrosion by the respective media.

By means of the sealing element and/or the supporting element, a sealed connection is created between the plates, which can be released without heating so that the plates are not destroyed or damaged.

In principle, several different materials are suitable for the sealing element provided that these can provide sufficient tightness and corrosion resistance for the particular heat exchange application. The sealing element according to the invention preferably comprises a fluoropolymer, for example polytetrafluoroethylene (PTFE). Furthermore, it is preferable for the supporting element according to the invention to comprise a fluoropolymer, for example PTFE.

The fluoropolymer can be selected from partially or fully fluorinated polymers. Polytetrafluorethylene (PTFE), ethylene tetrafluoroethylene (ETFE), polyvinylidene difluoride (PVDF), ethylene chlorotrifluoroethylene (ETCFE), fluorinated ethylene propylene copolymer (FEP) and perfluoroalkoxy polymers (PFA) are suitable as the fluoropolymer, for example. This applies both to the fluoropolymer of the sealing element and to the fluoropolymer of the supporting element. The fluoropolymer is particularly preferably PTFE. Fluoropolymers ensure both chemical and thermal resistance and tightness and mechanical properties such as effective transfer of force. It goes without saying that this property profile is fulfilled to varying degrees by different fluoropolymers, for example PTFE is particularly corrosion-proof. The tendency of some other fluoropolymers to creep is therefore lower.

The sealing elements and the supporting elements preferably consist of an identical material. The full bending strength of the heat-exchanging plates is then available for differences and fluctuations or jumps in the pressure of the media. Another advantage is that the supporting element and sealing element can be produced from spaced-apart portions of a precursor material in a particularly simple manner. The following are, for example, considered to be precursor material:
a sealing paste, such as the commercially available Chesterton® GoldEnd® 900 paste containing fluoropolymer particles,
a PTFE sealing tape (for example the commercially available GORE® gasket tape series 500), or
a fluoropolymer-containing sealing cord having a round cross section

The supporting elements are compressed between the heat-exchanging plates. In general, the thickness of the supporting element is no more than 10%, preferably no more than 4%, of the width of the supporting element. This is advantageous in that the plate heat exchanger has even higher stability with respect to jumps in pressure.

The sealing elements according to the invention have a specified thickness. The thickness of the sealing element is preferably no more than 10%, preferably no more than 4%, of the width of the sealing element. As a result, the plate heat exchanger also permanently withstands exceptionally high operating pressures.

The thickness of the supporting element and/or of the sealing element is preferably between 0.01 and 0.5 mm. The width of the supporting element and/or of the sealing element is preferably at least 3 mm, particularly preferably being between 3 and 20 mm. This also brings about optimum tightness and stability against high pressure differences.

The supporting element can be strip shaped. Strip shaped can be understood to mean that the supporting element has a specified width and a specified length, the length being at least five-times the width, for example. In this case, the supporting element does not have to be straight. This means that force is transmitted to the next heat-exchanging plate via the surface of the strip-shaped supporting element.

The supporting element can also be a support disc. According to the present invention, a support disc is a supporting element whose perimeter is at most twice as long as the perimeter of a circle having the same surface area. In practice, the support discs can be produced by using a paste as the precursor material and applying dots thereof in blobs. During compression, an almost round, flat support disc is formed from the precursor material. The dotted application carried out in this way means that less material is required for the supporting elements and the supporting elements can be individually attached in the region of the pressure difference peaks. Therefore, using the minimum amount of support material, deflection of the heat-exchanging plates can therefore be targetedly counteracted at precisely the point where the risk of material failure is at its highest.

The heat-exchanging plates can advantageously comprise graphite and/or a ceramic material and/or metal. Depending on the media between which the heat is exchanged, metals or metal alloys such as steel can be used as the material for the plates, or, for particularly corrosive media, ceramic materials such as silicon carbide or fibre-reinforced ceramic materials or graphite can also be used therefor.

A channel in the channel system can also comprise a flow-breaking element. A flow-breaking element is understood to mean elements that prevent the medium from being able to flow in a straight line in the channel direction. This causes the medium flowing through the channel to swirl and therefore causes the efficiency with which the heat is transferred to increase. A turbulent flow therefore occurs even at slower flow speeds of the medium.

The plate heat exchanger according to the invention advantageously comprises three heat-exchanging plates, which form a first channel system arranged between the first heat-exchanging plate and the second heat-exchanging plate and a second channel system arranged between the second heat-exchanging plate and the third heat-exchanging plate, wherein the first channel system is sealed by a first sealing element and a first supporting element included in the first channel system is aligned with a second supporting element included in the second channel system. In this case, aligned means that the perimeters of the first and second supporting element overlap, at least in part. Overlapping occurs when the perimeters extend such that at least one straight line oriented orthogonally to the plate planes passes through both perimeters. This means that the supporting elements are arranged in an axis extending perpendicularly to the surface of the heat-exchanging plates. The force acting on a heat-exchanging plate along the axis is therefore transferred to a different heat-exchanging plate by means of the supporting element and, in turn, continues to be transferred in the direction of force from here to the next heat-exchanging plate by means of the other supporting element.

The invention also relates to the use of the plate heat exchanger according to the invention for transferring heat from one medium to another medium, wherein one medium is corrosive or both media are corrosive. Corrosive can be understood to mean that the medium can impair the functions of materials, for example steels or other structural materials that come into contact with the medium, by a chemical reaction.

These corrosive media can be selected from hydrochloric acid, hydrofluoric acid, sulfuric acid, phosphoric acid and chloroacetic acid.

The invention also relates to the use of the plate heat exchanger according to the invention for transferring heat, wherein the pressure difference between one medium and the environment and/or the pressure difference between two media between which heat is transferred is at least 7 bar, preferably at least 9 bar, particularly preferably at least 11 bar, very particularly preferably at least 13 bar and extremely preferably at least 17 bar, for example at least 21 bar.

The invention also relates to a method in which heat is transferred from one medium to another medium in a plate heat exchanger according to the invention, wherein at least one of the two media is brought into physical contact with a foodstuff, a pharmaceutical product or a semiconductor material or is brought into contact with a precursor of the foodstuff, the pharmaceutical product or the semiconductor material.

### BRIEF DESCRIPTION OF THE FIGURES

The invention will be illustrated by the following embodiments and drawings, without being limited thereto.

FIG. 1 is a perspective view of a region of a heat-exchanging plate

FIG. 2 is a perspective view of a region of a heat-exchanging plate in which portions of a precursor material for supporting elements according to the invention have been applied

FIG. 3 is a cross section of a heat-exchanging plate in which precursor materials for sealing elements and for supporting elements according to the invention have been applied

### DETAILED DESCRIPTION

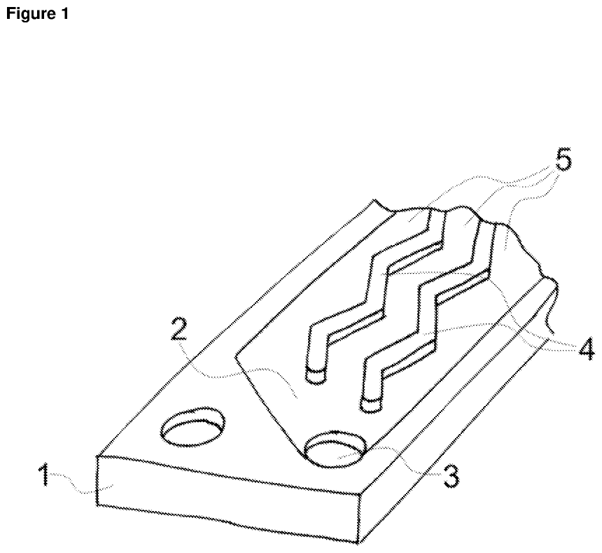

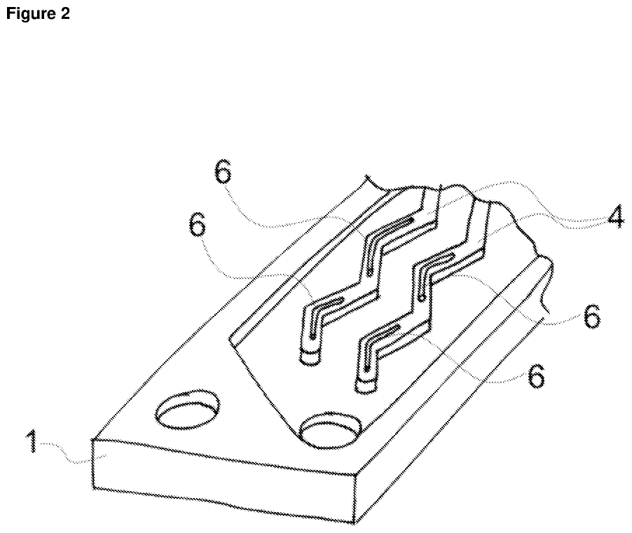

FIG. 1 shows a region of a typical heat-exchanging plate 1 for a plate heat exchanger. The heat-exchanging plate is profiled on the surface that is visible here such that, within the stack with another heat-exchanging plate (not shown here) arranged on said heat-exchanging plate, a channel system 2 is produced into which a medium can be introduced via a through-opening 3. The channels 5 included in the channel system are delimited by ridges 4. FIG. 2 shows the same perspective view of the same heat-exchanging plate 1, wherein portions of a supporting element precursor material 6 are additionally arranged on the ridges 4.

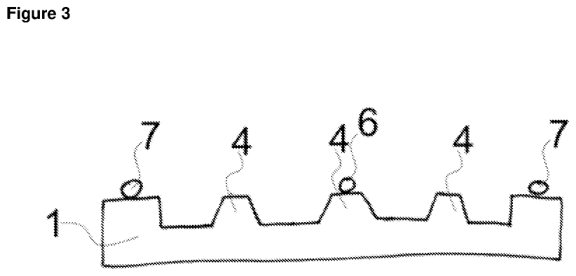

A supporting element precursor material 6 is also shown in the section shown in FIG. 3. The heat-exchanging plate from FIG. 3 is similar to the heat-exchanging plates from FIGS. 1 and 2, but here the ridges 4 have a trapezoidal cross section. FIG. 3 also shows a sealing element precursor material 7, which extends on the outer edge of the surface on all sides. By stacking and placing a plurality of the heat-exchanging plates shown in FIG. 3 under strain, the supporting element precursor 6 and sealing element precursor 7 arranged between the plates is compressed such that a heat exchanger according to the invention is provided, comprising sealing elements and supporting elements arranged according to the invention.

### EMBODIMENTS

Two small test plate heat exchangers (SiC PHX P05) each having 10 silicon carbide heat-exchanging plates were built. The dimensions of the plates for the P05 type were 230×620 mm. The heat-exchanging plates each comprise profiling that has been incorporated and openings for the media. The two test plate heat exchangers only differ by additional supporting elements according to the invention that have been only included in the second test plate heat exchanger.

For the two test plate heat exchangers, a sealing cord (PTFE-based, approx. 4 mm thick) was applied around each of the channel systems arranged between adjacent heat-exchanging plates and around the through-opening through which the other medium flows. The sealing cord was used to limit the regions through which the two media flow with respect to one another and to limit these regions with respect to the surrounding atmosphere.

In the second test plate heat exchanger, additional fluoropolymer supporting elements were applied to the ridges between the cooling channels. After placing the heat exchanger under strain, one of the two media flowed around the fluoropolymer supporting elements, and therefore they did not assume a sealing function.

In the first test plate heat exchanger, a test pressure of 8 bar was achieved. In the second test plate heat exchanger, a test pressure of 12 bar was achieved. First leakages only occurred in the second test plate heat exchanger at 13 bar test pressure.

The test pressure could therefore already be increased by 50% in this first, greatly simplified test setup.

In the event of loading, pressure is applied to the plate surface by contact with the media, which leads to deflection or to a corresponding state of mechanical stress. By means of the supporting elements, potential deflection is reduced or the corresponding stress is reduced. This allows for greater compressive loading in comparison with the initial state until a potential critical state of stress is reached with respect to the load on the plate (avoiding plate breakage) or with respect to the load on the system (avoiding leakages).

In other tests, plate heat exchangers according to the invention were able to achieve a resistance to pressure of 23.0 bar with silicon carbide heat-exchanging plates and a resistance to pressure of 25 to 26 bar with graphite heat-exchanging plates. This implies that the invention is not limited to plate heat exchangers comprising ceramic heat-exchanging plates, but can likewise be implemented especially effectively with other corrosion-proof plate materials.

By means of the 23 to 26 bar achieved, the leakages appeared in the same region both with silicon carbide heat-exchanging plates and with graphite heat-exchanging plates. The invention seems to have shifted the resistance to pressure limits more towards the clamping plates being made of steel (flatness) and the test equipment. If anything, leakages occur in the region of the supply and discharge lines or hose couplings.

1-15. (canceled)

16. A sealed plate heat exchanger, comprising: two heat-exchanging plates, which form a channel system arranged between the heat-exchanging plates that is sealed by a sealing element, wherein the channel system includes a supporting element spaced apart from the sealing element wherein a supporting element material differs from a material of a heat-exchanging plate.

17. The plate heat exchanger according to claim 16, wherein the supporting element is a supporting connection between the heat-exchanging plates.

18. The plate heat exchanger according to claim 16, wherein the sealing element comprises a circumferential sealing element region, is a self-contained circumferential tape or forms a tape contour, which is closed on all sides, by means of overlapping tape regions.

19. The plate heat exchanger according to claim 16, wherein the sealing element and/or the supporting element comprises a fluoropolymer.

20. The plate heat exchanger according to claim 19, wherein the fluoropolymer is selected from polytetrafluorethylene (PTFE), ethylene tetrafluoroethylene (ETFE), polyvinylidene difluoride (PVDF), ethylene chlorotrifluoroethylene (ETCFE), fluorinated ethylene propylene copolymer (FEP) and perfluoroalkoxy polymers (PFA).

21. The plate heat exchanger according to claim 16, wherein the thickness of the supporting element is no more than 10% of the width of the supporting element.

22. The plate heat exchanger according to claim 16, wherein the thickness of the sealing element is no more than 10% of the width of the sealing element.

23. The plate heat exchanger according to claim 16, wherein the thickness of the supporting element and/or of the sealing element is between 0.01 and 0.5 mm.

24. The plate heat exchanger according to claim 16, wherein the width of the supporting element and/or of the sealing element is at least 3 mm.

25. The plate heat exchanger according to claim 16, wherein the heat-exchanging plates comprise graphite and/or ceramic material and/or metal.

26. The plate heat exchanger according to claim 16, comprising three heat-exchanging plates, which form a first channel system arranged between the first heat-exchanging plate and the second heat-exchanging plate and a second channel system arranged between the second heat-exchanging plate and the third heat-exchanging plate, wherein the first channel system is sealed by a first sealing element and a first supporting element included in the first channel system is aligned with a second supporting element included in the second channel system.

27. A use of the plate heat exchanger according to claim 16 for transferring heat from one medium to another medium, wherein one medium is corrosive or both media are corrosive.

28. A use of the plate heat exchanger according to claim 27, wherein the corrosive media are selected from hydrochloric acid, hydrofluoric acid, sulfuric acid, phosphoric acid or chloroacetic acid.

29. A use of the plate heat exchanger according to claim 16 for transferring heat, wherein the pressure difference between one medium and the environment or the pressure difference between two media between which heat is transferred is at least 7 bar.

30. A method in which heat is transferred from one medium to another medium in a plate heat exchanger according to claim 16, wherein at least one of the two media is brought into physical contact with a foodstuff, a pharmaceutical product or a semiconductor material or is brought into contact with a precursor of the foodstuff, the pharmaceutical product or the semiconductor material.
